(19) United States
(12) Patent Application Publication
(10) Pub. No.: US 2015/0153266 A1
(43) Pub. Date: Jun. 4, 2015

(54) DETERMINING A RISK OF AQUAPLANING

(71) Applicant: Dr. Ing. h.c. F. Porsche Aktiengesellschaft, Stuttgart (DE)

(72) Inventor: Georg Mack, Eberdingen (DE)

(21) Appl. No.: 14/559,093

(22) Filed: Dec. 3, 2014

(30) Foreign Application Priority Data
Dec. 4, 2013 (DE) 102013113431.9

(51) Int. Cl. G01N 19/02; G01W 1/14; B60W 40/068

(52) U.S. Cl. CPC G01N 19/02; B60W 40/068; G01W 1/14

(57) ABSTRACT

A method for determining a risk of aquaplaning for a motor vehicle comprises steps of determining water on a road on which the motor vehicle is traveling, determining a coefficient of friction between a tire of the motor vehicle and the road being traveled on, determining tire properties, determining precipitation, determining cartographic information items of the road being traveled on, and determining, on the basis of the determined information, whether there is a risk of aquaplaning.

### CROSS-REFERENCE TO RELATED APPLICATION

This application claims priority under 35 U.S.C. §119 to German Patent Application No. DE 10 2013 113 431.9, filed Dec. 4, 2013, which is incorporated by reference herein it is entirety.

### FIELD OF THE INVENTION

The invention relates to technology for determining a risk of aquaplaning. In particular, the invention relates to a risk of aquaplaning for a motor vehicle which is traveling on a road.

If a motor vehicle is traveling on a wet road, a tire can aquaplane on the wetness and in the process lose road grip. Between the tire and the underlying surface there is then water so that the tire cannot transmit any guiding or braking forces of the motor vehicle to the underlying surface. The motor vehicle can then begin to skid.

### BACKGROUND OF THE INVENTION

Different proposals have been made for determining a risk of aquaplaning. DE 10 2004 044 788 A1, which is incorporated by reference herein, proposes determining a coefficient of friction between a tire of a motor vehicle and an underlying surface in order to be able to infer a risk of aquaplaning.

The invention is based on the object of making available a method and a device for the improved determination of a risk of aquaplaning. The invention solves these problems by means of a method and a device having the features of the independent claims. Dependent claims present preferred embodiments.

### SUMMARY OF THE INVENTION

A method according to the invention for determining a risk of aquaplaning for a motor vehicle comprises steps of determining water on a road on which the motor vehicle is traveling, determining a coefficient of friction between a tire of the motor vehicle and the road being traveled on, determining tire properties, determining precipitation, determining cartographic information items of the road being traveled on and determining, on the basis of the determined information, whether there is a risk of aquaplaning.

According to aspects of the invention, information items from a multiplicity of different sources are interlinked with one another in order to determine a risk of aquaplaning. In this context, use can be made of known technologies which are aimed at determining partial aspects which can lead to aquaplaning. In this way, for example factors which increase the risk of aquaplaning, for example wetness, can be weighed up with factors which reduce the risk of aquaplaning, for example a low speed, in order to determine the risk of aquaplaning as appropriately as possible. It is therefore possible for improved determination of the risk of aquaplaning to take place.

If a risk of aquaplaning is present, a corresponding signal can be output. The signal can be offered to a driver of the motor vehicle, for example optically, acoustically or haptically, so that said driver takes suitable measures in order to reduce the risk of aquaplaning. Additionally or alternatively, an automatic intervention into the control of the motor vehicle, in particular the longitudinal control, can also take place. In this context, the speed of the motor vehicle can preferably be lowered in order to reduce the risk of aquaplaning.

In a further embodiment, in addition a speed of the motor vehicle is determined and the risk of aquaplaning is additionally determined on the basis of the speed. Some of the described influencing factors are directly or indirectly dependent on the speed of the motor vehicle. By taking into account the speed of the motor vehicle it is possible for improved determination of the risk of aquaplaning to take place. Furthermore, speculative determination of the risk of aquaplaning can take place in that the risk is determined in advance for a higher or lower speed than that of the motor vehicle. It is possible to conclude therefrom whether increasing or reducing the speed of the motor vehicle will increase or lower the risk of aquaplaning by taking into account further applicable circumstances. In particular, the degree of the increase or lowering can be determined in this way. For a given threshold value which is to be accepted for the risk of aquaplaning it is then possible to determine whether (given a low risk of aquaplaning) it is possible to increase the speed without infringing of the threshold value, or whether (given a high risk of aquaplaning) reducing the speed is sufficient to lower the risk of aquaplaning below the threshold value.

In yet another embodiment, a sound resistance of the tire is determined and the risk of aquaplaning is additionally determined on the basis of the sound resistance. The sound resistance corresponds to a braking effect which is caused by the displacement of water by the tire. The higher the sound resistance, the greater the risk of aquaplaning.

In yet another embodiment, in addition a coefficient of friction between the tire and the road is determined, and the risk of aquaplaning is additionally determined on the basis of the coefficient of friction. The lower the coefficient of friction, the higher the risk of aquaplaning.

In one preferred embodiment, the risk of aquaplaning is determined by means of a multi-dimensional characteristic diagram. In this context, connection criteria can advantageously easily be modeled. If, for example, there is certainly no water on the underlying surface, the risk of aquaplaning can thus be determined as approximately 0, even if other criteria which are taken into account indicate a higher risk. A combination of a small tire profile with a high speed and a relatively high level of water on the road can, on the other hand, lead to a determination of a risk of aquaplaning which is so high that the aquaplaning can be considered to be certain even if other criteria which are taken into account indicate a relatively low risk. In both given examples, the other criteria may no longer be significant and be disregarded. Furthermore, the characteristic diagram can model empirical values which are usually acceptable to calculation only with difficulty, or even not at all. For example, a tire type or a tire manufacturer can be used as influencing factors for the determination of the risk of aquaplaning without assigning a numerical value to this information.

By means of the interlinking it is possible to determine an imminent risk of aquaplaning appropriately, for example in that it is determined that traveling in town traffic at a speed of 50 km/h entails a low risk of aquaplaning even if the tire has only a low residual profile depth and there is heavy precipitation.

In one embodiment, the tire properties comprise static information items, including at least one of a tire type, a tire dimension, a wear limit for a tire profile depth and a tire manufacturer.

In another embodiment, which can be combined with the last-mentioned embodiment, the tire properties comprise dynamic information items, including at least one of a tire profile depth and a tire inflation pressure.

In particular the static tire properties can be called, for example, in a wireless fashion by means of a tire ID chip which is permanently installed in the tire. In some embodiments, dynamic information such as the tire inflation pressure can also be determined by means of the tire pressure-monitoring system (referred to for short as TPMS for “Tire Pressure Monitoring System”). Further static tire properties can also be input manually, for example within the scope of a tire customer service. Further dynamic tire properties can be determined by means of measuring technology, for example, within the scope of the customer service or during operation of the motor vehicle.

The cartographic information items preferably include at least one of a road type and an aquaplaning risk zone. The road type can comprise a road class such as a freeway or a federal highway. For example it is known that a freeway usually has a lateral 2% gradient in order to conduct water to the edge of the roadway. The risk of aquaplaning is influenced by this. The type of road can also be known more precisely, for example a precise roadway covering in the region of the motor vehicle can be determined. In the case of a freeway, a concrete slab as roadway covering can have a different aquaplaning behavior than, for example, what is referred to as low-noise asphalt. An aquaplaning risk zone can be present, for example, if a traffic regulation which is dependent on wetness or a specific indication of a risk of skidding is present. A general warning, for example against ruts in the road, can also be determined as an aquaplaning risk zone. The cartographic information items can be obtained from a map memory with map data or be sensed in the surroundings of the motor vehicle, for example by means of an optical road sign recognition system.

A device according to the invention for determining a risk of aquaplaning for a motor vehicle comprises a first apparatus for determining water on a road on which the motor vehicle is traveling, a second apparatus for determining a coefficient of friction between a tire of the motor vehicle and the road, a third apparatus for determining tire properties, a fourth apparatus for determining precipitation, a fifth apparatus for determining cartographic information items of the road being traveled on, and a processing device which is configured to determine, on the basis of the determined information, whether there is a risk of aquaplaning.

The processing device is preferably additionally configured to compare the determined risk of aquaplaning with a predetermined threshold value, and output a signal if the determined risk of aquaplaning exceeds the threshold value. The signal can be directed, in particular, at a driver of the motor vehicle and can be offered acoustically, optically or haptically.

### BRIEF DESCRIPTION OF THE DRAWINGS

The invention will now be described in more detail with reference to the appended figures, in which:

FIG. 1 shows a flowchart of a method for determining a risk of aquaplaning;

FIG. 2 shows a device for determining a risk of aquaplaning;

FIG. 3 shows a diagram of a sound resistance of a tire as a function of a velocity and a water level;

FIG. 4 shows a diagram of a longitudinal slip of a tire as a function of a tire pressure;

FIG. 5 shows a diagram of a longitudinal slip of a tire as a function of a velocity, and

FIG. 6 shows a diagram of a longitudinal slip of a tire as a function of a tire profile depth.

### DETAILED DESCRIPTION OF THE INVENTION

FIG. 1 shows a flowchart of a method 100 for determining a risk of aquaplaning. The method 100 is based on the interlinking of a multiplicity of information items which can be determined independently of one another from various sources. In this context, a motor vehicle is assumed which comprises at least one wheel with a tire for making contact with a road. The motor vehicle moves at an intrinsic speed on the road, wherein the tire preferably rolls.

In a first step 105, water is determined on the road. In particular it is possible to determine whether the road is wet or, if water has collected on the road, how high the water is on the road. The determination in step 105 is preferably independent of a source of the water on the road. It is therefore possible, for example, to take into account water even if no precipitation is falling in the region of the motor vehicle.

In a step 110, the precipitation in the region of the motor vehicle is determined. The precipitation may be determined, for example, on the basis of meteorological information or sensor information such as, for example, a rain sensor or an ultrasonic sensor or a camera of a parking assistance system on board the motor vehicle. In one embodiment, the precipitation can also be classified. In this context, for example rain, sleet, snow and hail can be distinguished from one another. Although the determination of black ice is not part of the subject matter of the method 100, melting precipitation of snow or hail can also lead to water collecting on the road, with the result that there is a risk of aquaplaning.

In a step 115, cartographic information items of the road in the region of the motor vehicle are determined. In this context, in particular a road class can be determined. The road class can comprise, for example, a freeway, a country road, a town and a private road. In another embodiment, the road class can also comprise information on a roadway state, a roadway material and a roadway surface. The cartographic information items can originate from a map memory on board the motor vehicle, wherein a position of the motor vehicle may have been determined, for example, by means of a satellite navigation system.

Further cartographic information items can comprise indicated hazardous locations in the region of the motor vehicle. These hazardous locations may comprise, for example, a wetness-dependent speed restriction or a warning of ruts in the road, a risk of skidding or generally poor state of the road. The hazardous locations can be noted in the map data or can be detected by sensor by a road sign or a traffic information system in the region of the road.

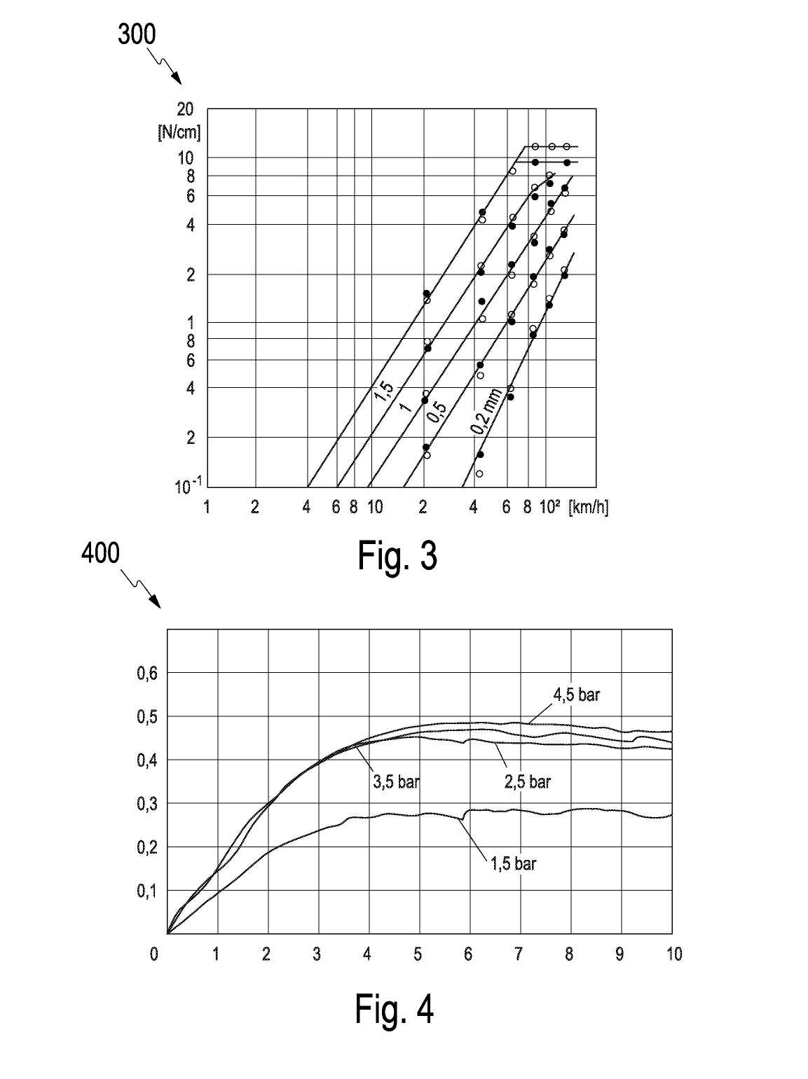

In an optional step 120 a surge resistance of the tire is determined. As is described below in more detail with respect to FIG. 3, the surge resistance can be measured by sensor or determined on the basis of a speed of the motor vehicle and a water level on the road. The surge resistance can be used as an indicator for a risk of aquaplaning.

In a step 125 a coefficient of friction between the tire and the road is determined. For this purpose it is possible to have recourse to existing technologies. However, the coefficient of friction can also be determined unconventionally, for example on the basis of data of an electronic stability program or an active steering system such as an electromechanical front-axle or rear-axle steering system for the motor vehicle.

In a step 130, properties of the tire are determined. These can include static information items such as a tire type (HP, UHP, all season, summer, winter etc.), a tire dimension (diameter, width, cross section etc.), recommendations for a tire inflation pressure, a minimum permissible or recommended residual profile depth and a tire manufacturer. Additionally or alternatively, dynamic information items can also be made available, for example a current residual profile depth, an unambiguous identifier of the tire, a manufacturing date of the tire, a history of the tire (when and where it has already been fitted), what mileage the tire has already incurred. In particular the dynamic information items, and if appropriate also some of the items of static information, can also be determined by sensor.

In a step 135, further information which can have an influence on the risk of aquaplaning can also be additionally taken into account. This can include, in particular, a speed of the motor vehicle.

In a step 140, the information items which are determined in the steps 105 to 135 are interlinked with one another and a risk of aquaplaning for the motor vehicle is determined. The interlinking can occur by means of a characteristic diagram, a numerical calculation or a combination of the two procedures. In one embodiment it is possible to determine whether or not there is a risk of aquaplaning. In another embodiment it is possible to determine how large the risk of aquaplaning is. In this case, the determined risk of aquaplaning can be compared with a predetermined threshold value in order to determine the presence of the risk of aquaplaning.

If there is a risk of aquaplaning, a signal can be output, in particular, to a driver of the motor vehicle. In one variant of the method 100, the signal can also be used to control the motor vehicle 100. In particular, when there is a risk of aquaplaning a speed of the motor vehicle can be reduced automatically or partially automatically.

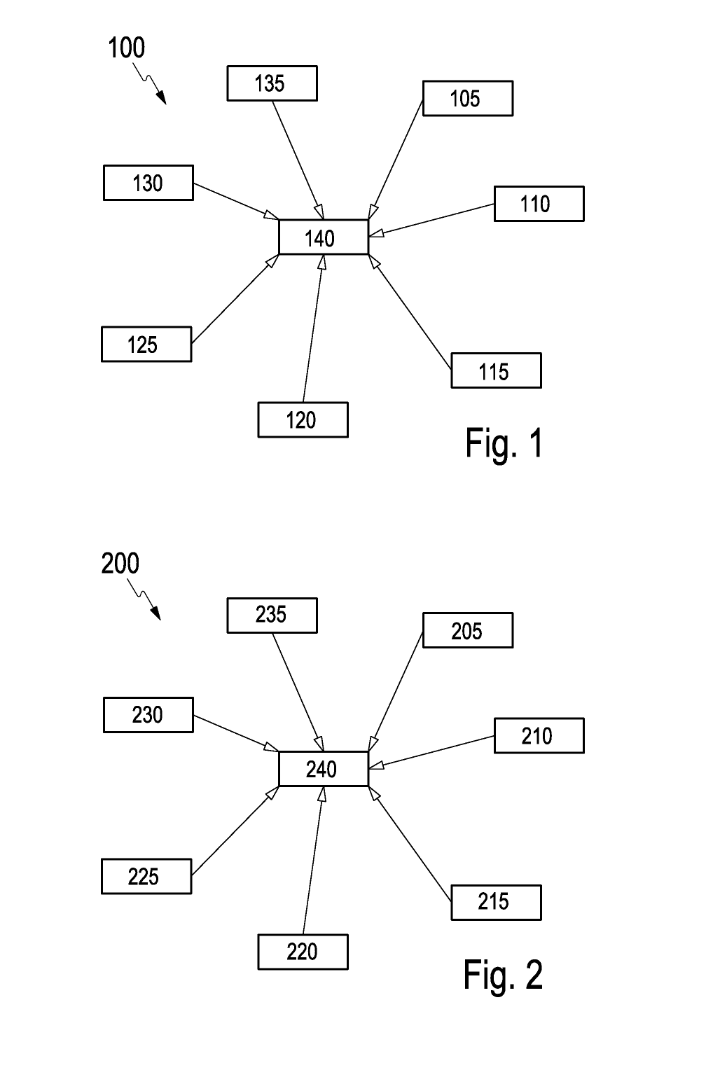

FIG. 2 shows a device 200 for carrying out the method 100. The individual elements of the device 200 are assigned in pairs to steps of the method 100 from FIG. 1. In another embodiment, a plurality of steps of the method 100 can also be carried out by means of a single element of the device 200.

An apparatus 205 is configured to determine water on the road according to step 105. In one embodiment, an optical camera, for example a rearview camera or a road sign recognition camera can detect water in the region of the road. For example a wake vortex can be determined if the motor vehicle, or another motor vehicle, causes water to swirl up from the road. In another embodiment, a microphone in the region of the motor vehicle, in particular in the passenger compartment, can be used to detect a characteristic noise if the motor vehicle is moving over a wet road. In yet a further embodiment, water on the road can be determined on the basis of a brief sound resistance at individual wheels or by means of a yaw rate of the motor vehicle.

Acceleration of the motor vehicle in the longitudinal direction can also be used to determine water on the road. The ultrasonic sensors of the parking assistance system are also sensitive to wetness or moisture.

An apparatus 210 is configured to determine precipitation according to step 110. Precipitation in the region of the motor vehicle can be determined, for example, by means of a rain sensor which usually evaluates water on a motor vehicle windshield by optical means. In addition, precipitation can be determined on the basis of a speed of a windshield wiper for cleaning the windshield.

An apparatus 215 for determining cartographic information items in the sense of step 115 preferably comprises a map memory in conjunction with a positioning apparatus. The positioning apparatus can comprise, in particular, a receiver for navigation signals, for example of a satellite navigation system such as GPS or GALILEO. The positioning apparatus and the map memory can form, in particular, parts of a navigation system for guiding the motor vehicle. Additionally or alternatively, a camera for optically detecting road signs or a traffic information system can be provided in the region of the motor vehicle. In particular, road signs which indicate an aquaplaning hazard location can be recognized. In future it will be possible to input up-to-date hazard indications into the navigation system via the mobile radio Internet or via radio reception.

An apparatus 220 for determining a sound resistance according to step 120 can determine the sound resistance of a tire by means of measuring technology or computationally. In the case of the computational determination, the sound resistance can be determined on the basis of a water level on the road and a speed of the motor vehicle. Alternatively, the sound resistance can also be measured, wherein in one embodiment the water level on the road can subsequently be determined on the basis of the speed of the motor vehicle.

An apparatus 225 is configured to determine a coefficient of friction according to step 125. The coefficient of friction can be determined in any desired fashion, for example one of the methods known from the prior art. Alternatively, another approach can also be used (for example on the basis of EPS or HAL).

An apparatus 230 for determining tire properties according to step 130 preferably comprises a tire ID chip which is permanently installed in the tire, and a wireless reading device. The tire ID chip is configured to make available tire properties of the tire. These can include static or dynamic information items. In a further embodiment, the tire ID chip is connected to a measuring device, with the result that dynamic information items such as a tire inflation pressure or mileage of the tire can also be made available. In another embodiment, a measuring device is provided for determining tire properties.

For example, a tire profile depth can be determined optically, or a tire inflation pressure can be determined acoustically.

Optionally, a further apparatus 135 for determining miscellaneous information can be provided according to step 135. For example, a speed sensor can be made available for determining the speed of the motor vehicle.

FIG. 3 is taken from the Springer training manual “Dynamik der Kraftfahrzeuge [Motor vehicle dynamics]” by Manfred Mitschke and Henning Wallentowitz and shows an exemplary diagram 300 of a sound resistance of a tire as a function of a speed of a motor vehicle and a water level of water on the road. The speed of the motor vehicle is plotted in the horizontal direction, and a related sound resistance is plotted in the vertical direction. Interpolated profiles for water levels of 0.2 mm, 0.5 mm, 1 mm, 1.5 mm and 2 mm are indicated. The measurements on which the illustration is based relate to a conventional tire whose values are represented by dark dots and a belted tire whose measured values are represented by light dots. According to the definition, the sound resistance corresponds to the difference between the rolling resistance of a tire on a wet road and that on a dry road. The sound resistance depends on the quantity of water which can be displaced by the tire in one time unit, i.e. on the speed of the motor vehicle and a surface which is bounded by a tire width and the water level. The sound resistance is usually independent of a tire design, a tire inflation pressure and a wheel load.

The following FIGS. 4 to 6 are taken from the specialist article “Der Nassgriff and das Aquaplaningverhalten von PKW-Reifen [Grip in the wet and the aquaplaning behavior of passenger car tires]” by Klaus-Peter Glaeser and Markus Fach [appeared in “Dokumentation Kraftfahrwesen [Motoring documentation]” e.V.).

FIG. 4 shows a diagram 400 of a longitudinal slip of a tire as a function of a tire inflation pressure. A longitudinal slip is entered as a percentage in the horizontal direction, and a circumferential coefficient of friction is entered in the vertical direction. Corresponding relationships are represented for different tire pressures of 1.5 bar, 2.5 bar, 3.5 bar and 4.5 bar. The relationships are to be understood as exemplary. It is apparent that as the tire pressure drops a contact pressure per unit area between the tire and the road decreases, as a result of which a tire footprint (a tire contact area) becomes larger and a risk of aquaplaning is increased.

The illustrated diagram relates to a tire with the dimensions 225/45 ZR 16 with 5 mm profile depth, in the case of a tire load of 2.5 kN, a speed of 80 km/h and a water film of 2 mm.

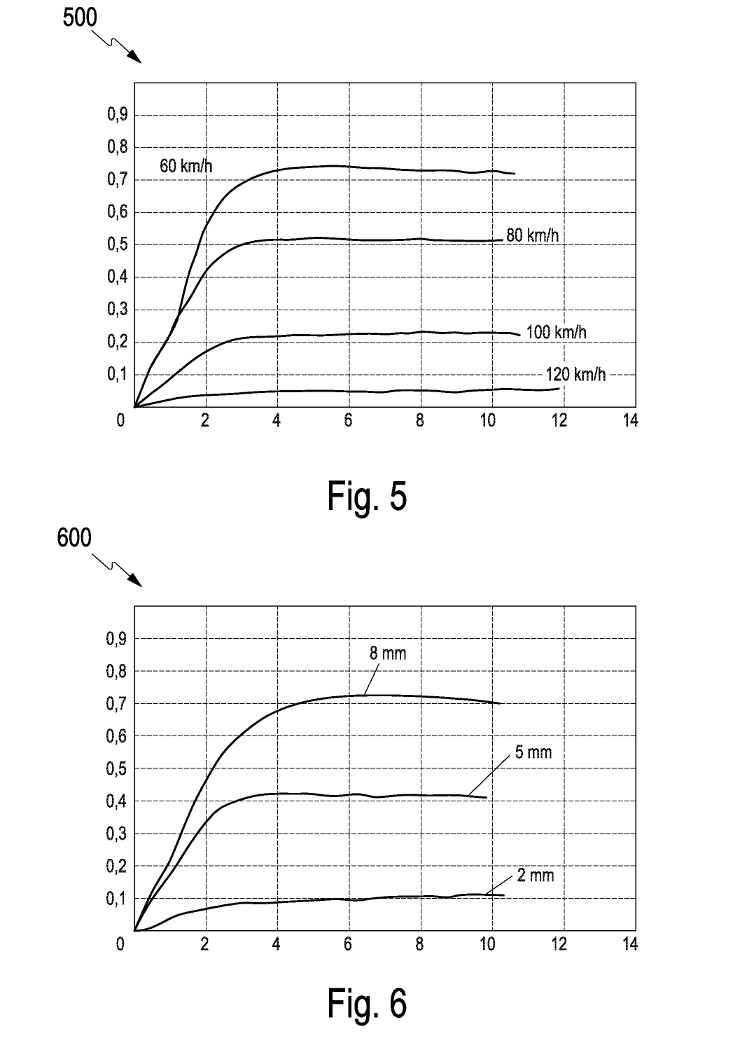

FIG. 5 shows a diagram 500 of a longitudinal slip of a tire as a function of a speed of the assigned motor vehicle. A longitudinal slip is entered as a percentage in the horizontal direction, and a circumferential coefficient of friction is entered in the vertical direction. A tire with the dimensions 225/45 ZR 16 with 5 mm profile depth, a tire load of 2.5 kN and a water film of 2 mm is used as the basis for the illustrated measurements. Different profiles for the speeds of the motor vehicle of 60, 80, 100 and 120 km/h are illustrated by way of example.

It is apparent that a risk of aquaplaning increases as the velocity is increased.

FIG. 6 shows a diagram 600 of a longitudinal slip of a tire as a function of a tire profile depth. A longitudinal slip is entered as a percentage in the horizontal direction, and a circumferential coefficient of friction is entered in the vertical direction. A tire with the dimensions 225/45 ZR 16 with a tire load of 2.5 kN, a velocity of 80 km/h and a water film of 2 mm is used as a basis for the illustrated measurements. Exemplary curves for tire profile depths of 2 mm, 5 mm and 8 mm are illustrated.

It is apparent that the risk of aquaplaning increases as the tire profile depth decreases.

What is claimed is:

1. A method for determining a risk of aquaplaning for a motor vehicle, comprising the following steps:
determining water on a road on which the motor vehicle is traveling;
determining a coefficient of friction between a tire of the motor vehicle and the road;
determining tire properties;
determining precipitation;
to determining cartographic information items of the road being traveled on, and
determining, on the basis of the determined information, whether there is a risk of aquaplaning.

2. The method as claimed in claim 1, wherein in addition a speed of the motor vehicle is determined and the risk of aquaplaning is additionally determined on the basis of the speed.

3. The method as claimed in claim 1, wherein in addition a sound resistance of the tire is determined and the risk of aquaplaning is additionally determined on the basis of the sound resistance.

4. The method as claimed in claim 1, wherein in addition a coefficient of friction between the tire and the road is determined, and the risk of aquaplaning is additionally determined on the basis of the coefficient of friction.

5. The method as claimed in claim 1, wherein the risk of aquaplaning is determined by means of a multi-dimensional characteristic diagram.

6. The method as claimed in claim 1, wherein the tire properties comprise static information items, including at least one of a tire type, a tire dimension, a wear limit for a tire profile depth and a tire manufacturer.

7. The method as claimed in claim 1, wherein the tire properties comprise dynamic information items, including at least one of a tire profile depth and a tire inflation pressure.

8. The method as claimed in claim 1, wherein the cartographic information items include at least one of a road type and an aquaplaning risk zone.

9. A device for determining a risk of aquaplaning for a motor vehicle, comprising the following:
a first apparatus for determining water on a road on which the motor vehicle is traveling;
a second apparatus for determining a coefficient of friction between a tire of the motor vehicle and the road,
a third apparatus for determining tire properties;
a fourth apparatus for determining precipitation;
a fifth apparatus for determining cartographic information items of the road being traveled on, and
a processing device which is configured to determine, on the basis of the determined information, whether there is risk of aquaplaning.
